(19) United States
(12) Patent Application Publication
(10) Pub. No.: US 2025/0080486 A1
(43) Pub. Date: Mar. 6, 2025

(54) COMMUNICATION APPARATUS AND EMAIL TRANSMISSION CONTROL METHOD

(71) Applicant: SHARP KABUSHIKI KAISHA, Osaka (JP)

(72) Inventor: KANJI NAKAGAWA, Osaka (JP)

(21) Appl. No.: 18/812,272

(22) Filed: Aug. 22, 2024

(30) Foreign Application Priority Data
Aug. 29, 2023 (JP) 2023-139151

(51) Int. Cl. H04L 51/23; H04L 51/224

(52) U.S. Cl. CPC H04L 51/23; H04L 51/224

(57) ABSTRACT

A communication apparatus includes a display that displays an operation screen for transmitting an email using a distribution service; and one or more controllers that control transmission of an email on a basis of an input content input via the operation screen, wherein in a case where an email address for logging into the distribution service and an email address of a sender of the email are different, before the email is transmitted, the one or more controllers display on the operation screen one or both of a warning of a possibility of non-delivery of the email and an operation option for checking arrival of the email.

### TECHNICAL FIELD

The disclosure relates to a communication apparatus and the like.

### BACKGROUND ART

When a scanned image is transmitted from a multifunction peripheral or the like to another apparatus by email, an email address of a user who has transmitted an email by operating the multifunction peripheral may be set in a sender field (also referred to as a “from field”).

### SUMMARY

### Technical Problem

An object of the disclosure is to provide a communication apparatus and the like that can appropriately transmit an email regardless of the email settings.

### Solution to Problem

To solve to problems described above, a communication apparatus according to the disclosure includes a display that displays an operation screen for transmitting an email using a distribution service; and one or more controllers that control transmission of an email on a basis of an input content input via the operation screen, wherein in a case where an email address for logging into the distribution service and an email address of a sender of the email are different, before the email is transmitted, the one or more controllers display on the operation screen one or both of a warning of a possibility of non-delivery of the email and an operation option for checking arrival of the email.

Also, a communication apparatus according to the disclosure includes one or more controllers that control transmission of an email in either a first mode or a second mode selected by a user when transmitting the email, the first mode being a mode in which an email is transmitted with an email address for logging into a distribution service being a display address and the second mode being a mode in which an email is transmitted with an email address of a sender input in an operation screen being a display address; and a transmitter that transmits the email on a basis of control by the one or more controllers, wherein in a case where the second mode has been selected by the user, the one or more controllers,
in a case where an email address for logging into the distribution service and an email address of a sender of the email are different, before the email is transmitted, displays on the operation screen one or both of a warning of a possibility of non-delivery of the email and an operation option for checking arrival of the email.

Furthermore, an email transmission control method according to the disclosure includes displaying an operation screen for transmitting an email using a distribution service; and controlling transmission of an email on a basis of an input content input via the operation screen; and in a case where an email address for logging into the distribution service and an email address of a sender of the email are different, before the email is transmitted, displaying on the operation screen one or both of a warning of a possibility of non-delivery of the email and an operation option for checking arrival of the email.

### Advantageous Effects of Invention

According to the disclosure, a communication apparatus and the like that can appropriately transmit an email regardless of the email settings can be provided.

### BRIEF DESCRIPTION OF DRAWINGS

FIG. 1 is a perspective view of a multi-function peripheral according to a first embodiment.

FIG. 2 is a functional configuration of the multifunction peripheral according to the first embodiment.

FIG. 3A is a diagram for explaining a login information management table.

FIG. 3B is a diagram for explaining a user information management table.

FIG. 3C is a diagram for explaining a transmission history table.

FIG. 4 is a flowchart for explaining a processing flow according to the first embodiment.

FIG. 5 is a flowchart for explaining a procedure according to the first embodiment.

FIG. 6 is a flowchart for explaining a procedure according to the first embodiment.

FIG. 7 is a flowchart for explaining a procedure according to the first embodiment.

FIG. 8 is a diagram for explaining an operation example according to the first embodiment.

FIG. 9 is a diagram for explaining an operation example according to the first embodiment.

FIG. 10 is a diagram for explaining an operation example according to the first embodiment.

FIG. 11 is a diagram for explaining an operation example according to the first embodiment.

FIG. 12 is a diagram for explaining an operation example according to the first embodiment.

FIG. 13 is a diagram for explaining an operation example according to the first embodiment.

FIG. 14 is a diagram for explaining an operation example according to the first embodiment.

FIG. 15A and FIG. 15B are diagrams for explaining operation examples according to the first embodiment.

FIG. 16A and FIG. 16B are diagrams for explaining operation examples according to the first embodiment.

FIG. 17 is a flowchart for explaining a processing flow according to a second embodiment.

FIG. 18 is a diagram for explaining an operation example according to a third embodiment.

### DESCRIPTION OF EMBODIMENTS

In a known image communication apparatus, when the apparatus transmits an email with an attached image file to another iFAX apparatus destination, the email address (device address) allocated to the apparatus is set in the sender field, and when the apparatus transmits an email address with an attached image file to an apparatus (destination) other than an iFAX apparatus, for the sake of the recipient, the email address of the user who operated the apparatus and issued an instruction to transmit the email is set in the sender field.

In the latter case, from the viewpoint of the provider, which is the transmission destination of the email transmitted by the apparatus, an email having a sender field that does not match the email address corresponding to the login information set in advance for use of email transmission is transmitted. When an email having a sender field that does not match the set email address is transmitted, in the case of a commercial email server such as a provider, this may be interpreted (misinterpreted) as a spoofing attempt and handled as a scam email. In this case, measures are taken which include rejecting the distribution of the email interpreted as the spoofing email, correcting the email address of the user input in the sender field to a preset email address, and the like.

In the past, such spoofing attempts have often been performed via spam email in which an advertisement or the like is unilaterally sent to an unspecified number of recipients. In addition to this, in recent years, with the rapid increase in fraudulent emails, each provider has strengthened measures against spoofing. For this reason, there is an increasing number of cases in which an email from a valid apparatus is handled as a scam email.

An object of the disclosure is to provide a communication apparatus or the like that can appropriately transmit an email regardless of the email settings. In particular, a communication apparatus or the like that can provide a countermeasure when there is a concern about a possibility of an email being determined as a spoofing email by a provider of a distribution service in email transmission in which a user email address is set in the sender field is implemented via the following embodiments.

Embodiments according to the disclosure will be described below with reference to the drawings. In the disclosure, an embodiment of an image processing apparatus will be described in which a communication apparatus according to the disclosure is implemented by a multifunction peripheral that can execute jobs involving copying, faxing, image transmitting, and the like with a single housing. Note that the following embodiments are examples for describing the disclosure, and the technical scope of the explanation described in the claims is not limited to the following description.

### 1. FIRST EMBODIMENT

### 1.1 Functional Configuration

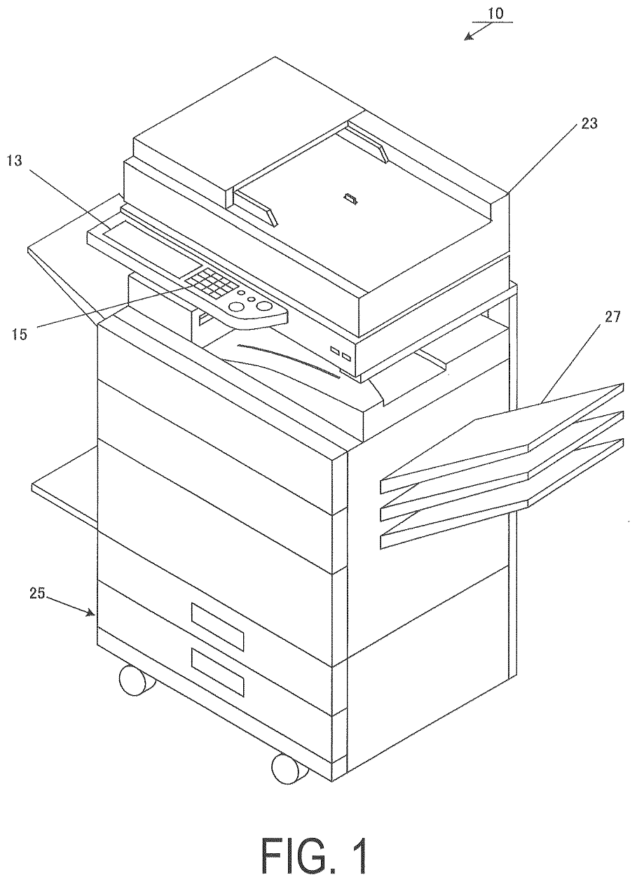

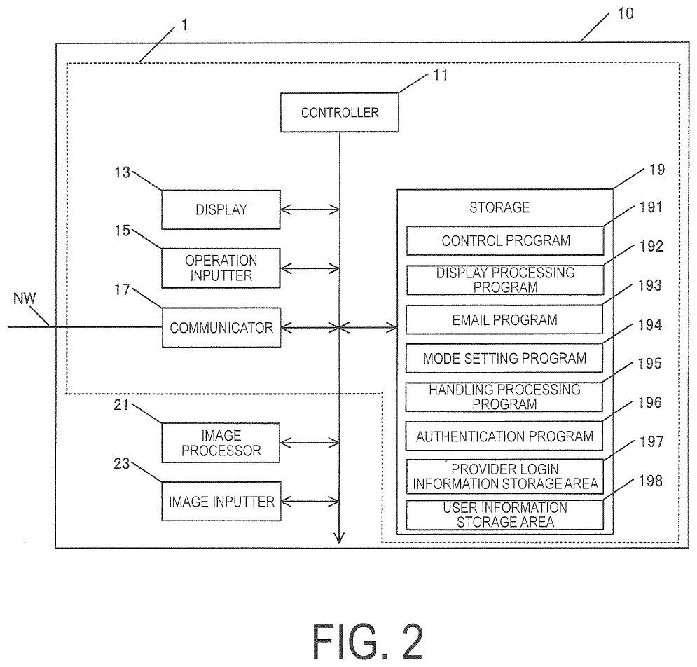

A functional configuration of a multifunction peripheral 10 according to the first embodiment will be described with reference to FIG. 1 and FIG. 2. FIG. 1 is an external perspective view for schematically explaining an overall configuration of the multifunction peripheral 10. FIG. 2 is a functional configuration diagram of the multifunction peripheral 10 implemented as a communication apparatus 1 according to the disclosure. The multifunction peripheral 10 includes an image processor 21 and an image inputter 23, in addition to the configuration of the communication apparatus 1 indicated by a dotted frame in FIG. 2.

A controller 11 controls the entire multifunction peripheral 10 and the communication apparatus 1. The controller 11 is configured to include, for example, one or multiple arithmetic devices (central processing units (CPUs) or the like). The controller 11 implements a function thereof by reading and executing various programs stored in a storage 19.

A display 13 is a display device that displays various types of information for a user or the like. The display 13 can be configured to include, for example, an LCD, an organic electro-luminescence (EL) display, or the like.

An operation inputter 15 receives an input of information by the user or the like. The operation inputter 15 can be configured to include, for example, various input devices such as operation keys (for example, hardware keys and software keys) and buttons. Note that the operation inputter 15 can be configured as a touch panel display that enables input via the display 13. In this case, as an input method for the touch panel, for example, a general method such as a resistance film method, an infrared beam method, an electromagnetic induction method, or an electrostatic capacitance method can be employed.

A communicator 17 includes, for example, one or both of wired and wireless interfaces for performing communication with other non-illustrated devices via a network NW such as a local area network (LAN), a wide area network (WAN), the Internet, a telephone line, or a fax line. The communicator 17 can function as a transmitter that transmits emails on the basis of control by the controller 11 that has read an email program 193 described below. The communicator 17 may include an interface related to a (short-range) wireless communication technology such as Bluetooth (trade name), near-field communication (NFC), Wi-Fi (trade name), ZigBee (trade name), IrDA, or a wireless USB.

The storage 19 stores various programs and various types of data necessary for the operation of the multifunction peripheral 10 and the communication apparatus 1. The storage 19 can be configured to include, for example, one or more storage device (memory) such as a random access memory (RAM), a hard disk drive (HDD), a solid state drive (SSD), or a read only memory (ROM).

In the first embodiment, the storage 19 stores a control program 191, a display processing program 192, the email program 193, a mode setting program 194, a handling processing program 195, and an authentication program 196 and allocates a provider login information storage area 197 and a user information storage area 198.

The control program 191 is a program read by the controller 11 for performing centralized control of the entire multifunction peripheral 10 and the communication apparatus 1. By the controller 11 that has read the control program 191 controlling the display 13, the operation inputter 15, the communicator 17, the image processor 21, or the image inputter 23, for example, a function performed by the multifunction peripheral 10 as a job can be implemented including copying, faxing, transmitting an email of a scanned image, and the like.

The display processing program 192 is a program read by the controller 11 when a login screen, an email settings screen, an operation screen including a warning, an operation option, and the like, which will be described below, are displayed on the display 13. The controller 11 that has read the display processing program 192 displays each screen and the like on the display 13 using image content (not illustrated) stored in the storage 19.

The email program 193 is a program which conforms to a protocol such as Simple Mail Transfer Protocol (SMTP), Post Office Protocol (POP) version 3, or the like, and is read by the controller 11 when transmitting and receiving an email. The controller 11 that has read out the email program 193 functions as an email application that transmits and receives emails to and from a provider that provides a (email) distribution service on the basis of preset login information. The email settings screen displayed by the controller 11 will be described below.

The mode setting program 194 is a program that is read by the controller 11 when receiving a selection of an email transmission mode out of a first mode in which an email is transmitted using an email address for logging in to a distribution service as a display address for a recipient (destination) and a second mode in which an email is transmitted using an email address of a sender input to an email settings screen corresponding to a settings screen as a display address for a recipient. The controller 11 that has read the mode setting program 194 accepts selection of a transmission mode by the user via a system settings screen (not illustrated). The controller 11 stores the setting value related to the received mode selection in the storage 19. The controller 11 functioning as the email application can transmit emails in either the first mode or the second mode on the basis of the setting value related to the mode selection.

The handling processing program 195 is a program that is read by the controller 11 when executing handling processing as a countermeasure for a concern about a possibility of an email transmitted to a provider being determined as a spoofing email. Specifically, when the email transmission mode is the second mode and the email address for logging in to the provider is different from the email address of the sender (automatic input or manual input) before the email transmission, the controller 11 that has read out the handling processing program 195 determines that the email to be transmitted is a spoofing email and there is a possibility that the distribution of the email is rejected or the email address input in the sender field is corrected. In this case, the controller 11 displays a warning of the possibility of the email not being delivered on the operation screen. In addition to or instead of the warning, the controller 11 displays handling processing that can be executed as a countermeasure as an operation option as described below.
(1) Test-transmission of an email (test email) to sender who issued the email transmission instruction
(2) Notification to email recipient
(3) Transmission of email to sender in addition to email recipient

The controller 11 executes the handling processing related to the operation option selected by the user. Note that in the disclosure, not delivered refers to the original function and form of the email at the time of transmission not being retained, such as when an email does not arrive (not distributed) due to email distribution being reject or when the email arrives (distributed) with a corrected email address in the sender field.

The authentication program 196 is a program read out by the controller 11 when the controller 11 is to authenticate a user who attempts to log into the multifunction peripheral 10. In a case where the controller 11 that has read out the authentication program 196 is functioning as an authenticator and the user authentication function is enabled, the login screen described below is displayed on the display 13 and the input of a login user name and login password is accepted. The controller 11 can perform user login authentication by storing login user names and login passwords related to the user authentication in association with each other in advance as a user information management table 1981 described below and checking the login user name and the login password input via the login screen against the stored login user names and login passwords. Note that the login authentication may be, for example, possession-based authentication using a token, a key, an integrated circuit (IC) card, or a smartphone, or biometric authentication such as face authentication or fingerprint authentication, in addition to knowledge-based authentication based on the input of a login user name and a login password.

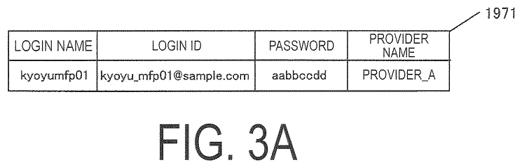

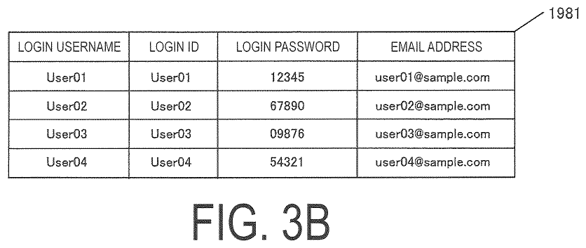

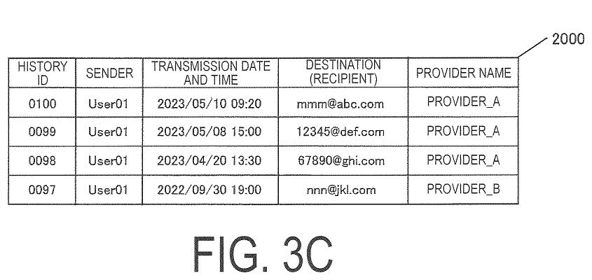

The provider login information storage area 197 is a storage area that stores login information for the multifunction peripheral 10 to log in to the provider. An example of the configuration of a login information management table 1971 managed in the provider login information storage area 197 will be described with reference to FIG. 3A.

The login information management table 1971 includes a login name, a login ID, a password, and a provider name. The login name (kyoyumfp01) indicates the name of the multifunction peripheral 10 that logs in to the provider. The login ID (kyoyu_mfp01@sample.com) is an identifier for identifying the multifunction peripheral 10 in the provider. The password (aabbccdd) indicates a password for logging into the provider. The provider name (provider_A) is the name of a provider from which the multifunction peripheral 10 receives an email distribution service. The information other than the provider name managed in the login information management table 1971 is the same information as the login information (authentication information) managed by the provider (provider_A). In this example, the login ID is a device address (kyoyu_mfp01@sample.com) assigned to the multifunction peripheral 10, but the login ID is not limited to this and may be a character string of alphanumeric characters, kana characters, or symbols, for example, “kyoyu_mfp01”. The multifunction peripheral 10 can log in to the provider (provider_A) using the login ID (login name if necessary) and the password. Note that the email address indicated by the login ID is also an example of an email address used by the provider as a display address for the recipient when the email transmission mode is the first mode.

The user information storage area 198 of FIG. 2 is a storage area for storing user information related to a user who logs in to the multifunction peripheral 10. An example of the configuration of the user information management table 1981 managed in the user information storage area 198 will be described with reference to FIG. 3B.

The user information management table 1981 includes a login user name, a login ID, a login password, and an email address. The login user name (for example, User01) indicates the name of a user who has logged in to the multifunction peripheral 10. The login ID (for example, User01) is an identifier for identifying a login user who has logged in to the multifunction peripheral 10. The login password (for example, 12345) indicates a password for the user to log in to the multifunction peripheral 10. The email address (for example, user01@sample.com) indicates an email address assigned to the login user. A user who tries to log in to the multifunction peripheral 10 can log in to the multifunction peripheral 10 as an authenticated user by inputting a login user name (a login ID if necessary) and a login password to a login screen described below and succeeding in user authentication. Note that the email address of the login user corresponding to the login ID is also an example of an email address used as a display address for the recipient when the email transmission mode is the second mode.

In the embodiment described here, in the login information management table 1971 illustrated in FIG. 3A and the user information management table 1981 illustrated in FIG. 3B, the login information and the user information are managed in a table format. However, no such limitation is intended, and this information can be managed in a database.

Returning to FIG. 2, the image processor 21 forms an image based on image data on a sheet or the like serving as a recording medium. The image processor 21 feeds a sheet from a feed tray 25, forms an image on the sheet based on image data, and then discharges the sheet to a paper discharger 27. The image processor 21 can be configured to include, for example, a laser printer using an electrophotographic system. In this case, the image processor 21 performs image formation using toners supplied from toner cartridges (not illustrated) corresponding to toner colors (for example, cyan, magenta, yellow, and black). The image processor 21 may perform, for example, shading correction or density correction on image data input from the image inputter 23 to generate output image data (image file) for image transmission.

The image inputter 23 generates image data by scanning a document. The image inputter 23 can be configured as a scanner device that is provided with an image sensor such as a charge coupled device (CCD) or a contact image sensor (CIS) and that includes an automatic document feeder (ADF), a flatbed on which a document is placed to be read, and the like. The configuration of the image inputter 23 is not particularly limited as long as the image inputter 23 can generate image data by reading a reflected light image from an original image using the image sensor. Note that the image inputter 23 can be configured as an interface that can acquire image data stored in a portable storage medium such as a universal serial bus (USB) memory and image data transmitted from an external terminal device (not illustrated).

### 1.2 Processing Flow

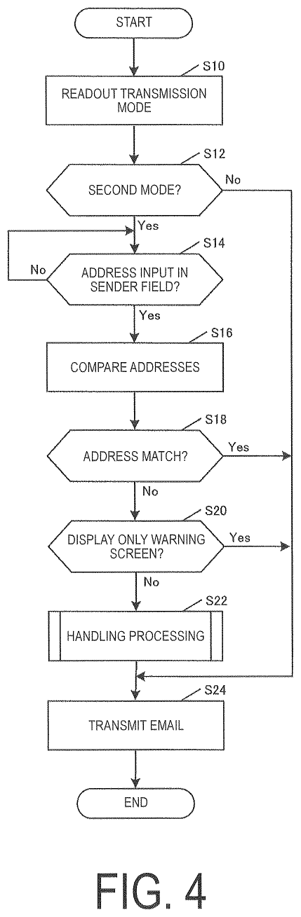

Next, a procedure according to the first embodiment will be described. FIG. 4 is a flowchart for explaining main processing of the multifunction peripheral 10. The processing illustrated in FIG. 4 is executed when the controller 11 reads the control program 191, the display processing program 192, the email program 193, the mode setting program 194, the handling processing program 195, the authentication program 196, and the like.

The controller 11 reads out a setting value of a transmission mode related to email transmission, triggered by, for example, a display timing of an email settings screen described below (step S10).

The controller 11 determines whether or not the setting value of the read transmission mode is a setting value related to the second mode (step S12). In a case where it is determined that the read setting value of the transmission mode is a setting value related to the second mode, the controller 11 determines whether or not the email address of the sender is input in the sender field (step S12; Yes→step S14). In a case where it is determined that the email address of the sender is not input in the sender field, the controller 11 stands by until the email address is input in the sender field (step S14; No).

In a case where it is determined that the email address of the sender is input in the sender field, the controller 11 compares the email address for logging in to the provider with the email address input in the sender field (step S14; Yes→step S16). Note that the comparison of the email addresses may be triggered by the selection of the start button on the email settings screen.

As a result of the comparison of the email addresses, if the email address for logging in to the provider and the email address input in the sender field do not coincide with each other, the controller 11 displays one or both of a warning of a possibility of the email to be transmitted not being delivered and an operation option for confirming the delivery of the email on the operation screen (step S18; No→step S20). Here, in a case where the display setting for displaying only the warning screen is set as the device setting (system setting), after the warning screen is displayed, the controller 11 receives an instruction for email transmission from the user, transmits the email, and ends the processing (step S20; Yes→step S24). On the other hand, in a case where the display setting in which the operation option for confirming the email arrival is displayed together with the warning screen as the handling processing, the handling processing is executed on the basis of the operation option selected by the user (step S20; No→step S22).

On the basis of the result of the handling processing related to step S22, the controller 11 transmits an email and ends the processing (step S24→end).

In a case where it is determined that the read setting value of the transmission mode is not a setting value related to the second mode (step S12; No) or in a case where the email address for logging in to the provider and the email address input in the sender field match (step S18; Yes), the controller 11 determines that the transmission mode is the first mode. Then, the controller 11 transmits the email and ends the processing (step S24→end).

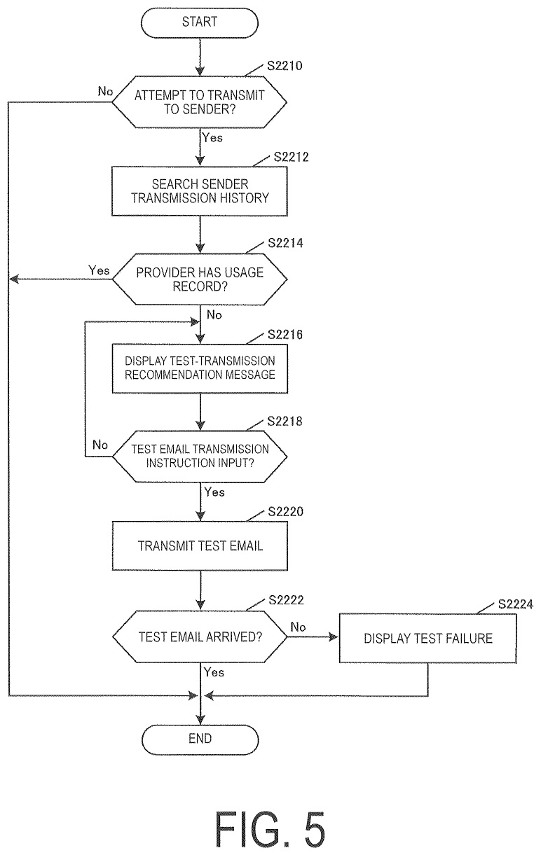

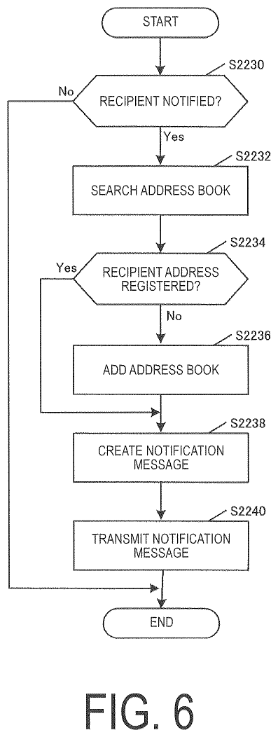

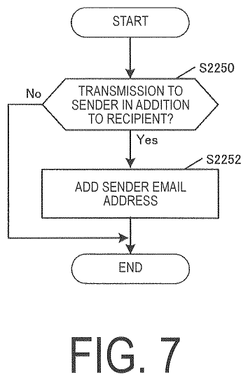

Next, the handling processing related to step S22 of FIG. 4 will be described with reference to the flowchart illustrated in FIG. 5 to FIG. 7. The processing illustrated in FIG. 5 to FIG. 7 is executed when the controller 11 reads the control program 191, the display processing program 192, the email program 193, the mode setting program 194, the handling processing program 195, the authentication program 196, and the like. When the user is logged in to the multifunction peripheral 10, and the login user can select, as a sender, one or a combination of operation options including (1) test-transmitting a test email to the sender who issued the email transmission instruction (FIG. 5), (2) notifying the email recipient (FIGS. 6), and (3) transmitting an email to the sender in addition to the email recipient (FIG. 7).

### (1) Test-transmission of a Test Email to a Sender Who Issued the Email Transmission Instruction

The controller 11 determines whether or not the user has selected, as an operation option, the test-transmission of a test email to the sender who issued the email transmission instruction (step S2210). In a case where it is determined that the sender has selected the test-transmission of a test email, the controller 11 searches the email transmission history of the sender (step S2210; Yes→step S2212). Note that in a case where it is determined that the sender has not selected the test-transmission of a test email, the controller 11 determines that the operation option is not selected and ends the processing (step S2210; No→end). The email transmission history of the sender will be described with reference to FIG. 3C.

FIG. 3C is a diagram illustrating an example of the configuration of a transmission history table 2000 in a case where the sender (login user) is User01. The transmission history table 2000 illustrated in FIG. 3C includes a history ID, a sender, a transmission date and time, a destination (recipient), and a provider name and is a table in which transmission histories are arranged in descending order from a latest email transmission date and time to an oldest email transmission date and time. Here, the history ID is an identifier for uniquely identifying the email transmission history. The sender indicates the login user name (User01) of the login user who transmitted the email. The transmission date and time indicates the date and time when the sender transmitted the email. The destination (recipient) indicates the destination of the email. The provider name indicates a provider name used by the sender.

For example, the transmission history represented by the history ID “0100” represents a history of an email transmission to mmm@abc.com at 09:20 on 2023 May 10 by User01 and represents that the email was transmitted using the provider_A. Also, the transmission history represented by the history ID “0097” represents a history of an email transmission to nnn@jkl.com at 19:00 on 2022 Sep. 30 by User01 and represents that the email was transmitted using the provider_B.

The controller 11 can determine the usage record for the provider based on the email transmission date and time (transmission date and time), the name of the provider used, and the like of the transmission history table 2000. Although there is no particular limitation on the method of determining the usage record of the provider, for example, the controller 11 can determine the usage record of the provider by checking whether or not an email has been transmitted to the target provider within a preset usage period. For example, in a case where the preset usage period is six months, according to the example of FIG. 3C, six months or more have elapsed from the date and time (2022 Sep. 30 19:00) at which the email was last transmitted using the provider_B to the latest transmission history (history ID: 0100). In this case, the controller 11 can determine that there is no usage record for the provider_B. Note that the determination of the usage record of the provider may be made in consideration of the number of times the target provider is used, the ratio of the number of times the target provider is used to the total number of use times, or the like.

Referring back to FIG. 5, in a case where it is determined that there is a usage record of email transmissions to the target provider, the controller 11 determines that test-transmission of a test email to the provider is not necessary and ends the processing (step S2214; Yes→end).

On the other hand, in a case where it is determined that there is no usage record of email transmission to the target provider, the controller 11 displays a recommendation message for test-transmission of a test email to the provider on the operation screen (step S2214; No→step S2216).

The controller 11 receives the display of the test email test-transmission recommendation message and determines whether or not a transmission instruction for the test email has been input by the sender (step S2218). In a case where it is determined that a test email transmission instruction has been input by the sender, the controller 11 transmits a test email to the sender (step S2218; Yes→step S2220). In a case where it is determined that a test email transmission instruction has not been input, the controller 11 continues the display of the test email test-transmission recommendation message until a test email transmission instruction is input by the sender (step S2218; No→step S2216).

Then, the controller 11 determines whether or not a test email has arrived (step S2222). Whether or not the test email has arrived can be determined by the reception of the test email transmitted on the basis of a transmission instruction by the sender. In a case where the transmitted test email is received, the controller 11 ends the processing (step S2222; Yes→end). On the other hand, if the transmitted test email is not delivered, for example, if an error email is received, the controller 11 displays a message indicating that the test has failed on the operation screen and ends the processing (step S2222; No→step S2224→end).

### (2) Notification to Email Recipient

The controller 11 determines whether or not notify email recipient has been selected by the user as an operation option (step S2230). In a case where it is determined that notification to the recipient has been selected by the sender, the controller 11 searches the address book managed by the multifunction peripheral 10 and determines whether or not a notifier or a notification destination for notifying the recipient via SMS (Short Message Service), SNS (Social Networking Service), a dedicated application, or the like is registered in the address book (step S2230; Yes→step S2232). The notification to the recipient is preferably performed via a communicator or a communication destination other than email transmission, such as SMS, SNS, or a dedicated application, in consideration of the arrival probability of the notification to the recipient. Note that in a case where it is determined that the sender has not selected the notification to the email recipient, the controller 11 determines that the operation option is not selected and ends the processing (step S2230; No→end).

In a case where it is determined that the notifier or notification destination for notifying the recipient is registered in the address book, the controller 11 creates a notification message including a message to post an email (step S2234; Yes→step S2238). On the other hand, in a case where it is determined that the notifier or the notification destination for notifying the recipient is not registered in the address book, the controller 11 causes the sender to add the notifier or the notification destination for notifying the recipient to the address book and creates a notification message related to email transmission (step S2234; No→step S2236→step S2238).

The controller 11 transmits the notification created in step S2238 to the receiver and ends the processing (step S2240→end).

### (3) Transmission of Email to Sender in Addition to Email Recipient

The controller 11 determines whether or not transmission of the email to the sender in addition to the email recipient is selected (step S2250). In a case where it is determined that transmission of the email to the sender in addition to the email recipient has been selected by the sender, the controller 11 adds the email address of the sender to the destination of the email to be transmitted and ends the processing (step S2250; Yes→step S2252→end). Note that in a case where it is determined that the sender has not selected the transmission of the email to the sender in addition to the email recipient, the controller 11 determines that the operation option is not selected and ends the processing (step S2250; No→end).

### 1.3 Operation Examples

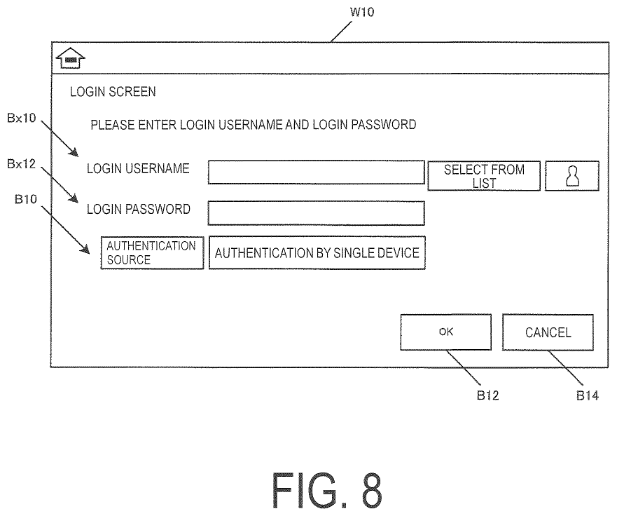

Next, operation examples according to the first embodiment will be described. FIG. 8 is a diagram for explaining an example of a display configuration of a login screen W10 displayed on the display 13 by the controller 11 of the multifunction peripheral 10. In a case where the user authentication function is enabled, the login screen W10 can be configured as a login screen to be displayed on the display 13 by the controller 11 after the controller 11 reads out the authentication program 196.

The login screen W10 includes a login user name input box Bx10, a login password input box Bx12, an authentication source designation button B10, an OK button B12, and a cancel button B14.

The login username input box Bx10 receives an input of a login username of the user who attempts to log in to the multifunction peripheral 10. Note that the login username may be directly input by using an input device such as a keyboard, or may be input by selecting a username from a list of usernames, which is displayed by the user operating a selection button from a list provided separately.

The login password input box Bx12 is an input box for receiving an input of a login password corresponding to the login username. The user who attempts to log in to the multifunction peripheral 10 inputs the login password together with the login username.

The authentication destination designation button B10 is a button for receiving designation of a user authentication source. The user authentication source may be a single device or may be, for example, an authentication server or the like separately provided on the network (NW). In a case where a single device is designated as the user authentication source, the controller 11 performs user authentication by comparing the input login user name and login password with the user information management table 1981. On the other hand, in a case where the authentication server provided on the network (NW) is designated as the user authentication source, the controller 11 performs user authentication by transmitting the input login user name and login password to the authentication server and receiving an authentication result from the authentication server.

The OK button B12 is a button for receiving input of an instruction to finalize the input operation by the user. The user selects the OK button B12 to confirm the input to the login user name input box Bx10 or the login password input box Bx12 and the designation of the user authentication source via the authentication source designation button B10. The cancel button B14 is a button for receiving an instruction to cancel the input operation by the user.

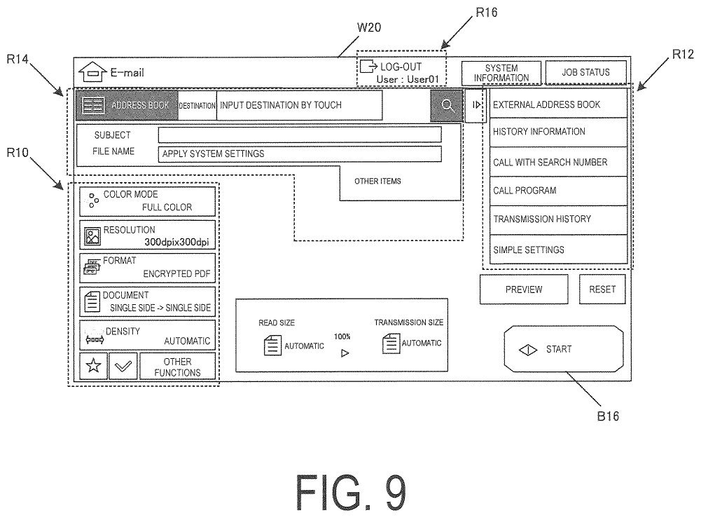

FIG. 9 is an example of the display configuration of a settings screen W20 related to a “scan to email” transmission job corresponding to a settings screen displayed by the controller 11.

The settings screen W20 includes a setting value display area R10, a control button display area R12, a destination display area R14, a login user name display area R16, and a start button B16.

The setting value display area R10 receives selection and input of a setting value that can be set by the sender via the settings screen W20. FIG. 9 is an example in which setting values (items) such as color mode (full color), definition (300 dpi×300 dpi), format (encrypted PDF), document (single-sided→single-sided), and density (automatic) are displayed as settable setting values (items).

The control button display area R12 includes, for example, an external address book button, a history information button, a button for calling by search number, a program calling button, a transmission history button, a simple settings button, and the like. For example, the external address book button is a button for receiving an address book call instruction obtained from an external terminal device such as a smartphone connected via the communicator 17. The history information button is a button for receiving an instruction to call a settings history storing a setting value related to execution of a job. The button for calling by search number is a button for receiving an input of a search instruction for a transmission destination via a search number. The program calling is a button for receiving a call instruction of a job program in which setting contents related to a transmission job are stylized. The transmission history button is a button for receiving an instruction to display the transmission history table 2000 illustrated in FIG. 3C. The simple settings button is a button for receiving switching of a display instruction to a simple settings screen obtained by further simplifying the settings screen W20 illustrated in FIG. 9.

The destination display area R14 is a display area for receiving designation of an address of a destination (recipient) of email transmission. The destination display area R14 is an area for receiving an email subject, an image file name of a scanned image or the like attached to the email, and sender field settings to be described in the next diagram.

The login user name display area R16 is a display area for displaying the names of login users who have logged in to the multifunction peripheral 10 via the login screen W10 of FIG. 8. A logout button is provided in the login user name display area R16 and can receive an input of a logout instruction from the multifunction peripheral 10.

The start button B16 receives an instruction to execute email transmission. When the start button B16 is selected by the user, the controller 11 controls the image inputter 23 to start scanning of the document image and execute email transmission with the image file generated by the image processor 21 attached.

In the disclosure, when the email transmission mode is the second mode, the email address of the login user can be automatically set in the sender field. Specifically, the controller 11 reads out the email address of a login user who has successfully logged in from the user information management table 1981 and stores the email address in a primary storage device such as a RAM at the time of login processing for the multifunction peripheral 10. Then, the controller 11 can implement automatic setting of the sender field by setting the stored email address in the sender field with a display instruction of the settings screen W20 related to a “scan to email” transmission job as a trigger, for example.

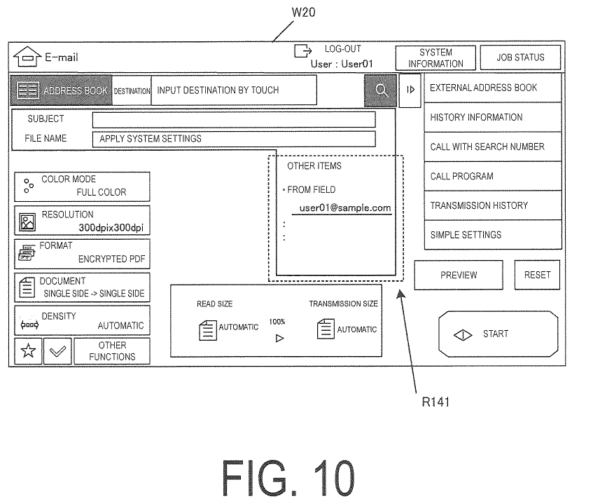

On the other hand, in the disclosure, setting of the sender field can also be performed manually. FIG. 10 illustrates an example in which a sender field input area R141 for receiving an input of an email address to be set in the sender field is provided in the destination display area R14 of the settings screen W20 illustrated in FIG. 9. The sender field input area R141 is configured to allow manual input of a desired email address as a display address for the recipient. By providing the sender field input area R141, for example, even when the automatic setting function of the sender field is set to disabled or when setting of an email address (for example, an email address of a guest user) other than the email address of the login user is desired, it is possible to set an email address in the sender field.

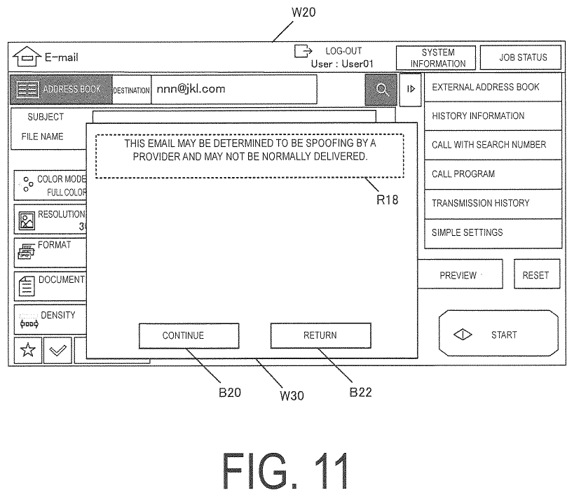

FIG. 11 is a diagram for explaining a display configuration example of a warning screen for the possibility of non-delivery of an email to be transmitted. FIG. 11 illustrates an operation example corresponding to the processing of step S20 (; Yes) in FIG. 4.

An operation screen W30 includes a warning display area R18, a continue button B20, and a return button B22.

The warning display area R18 is a display area for displaying contents for warning of the possibility of non-delivery of an email to be transmitted (for example, that there is a possibility of the email being determined to be spoofing by the provider not being normally delivered).

The continue button B20 is a button for receiving an instruction to execute email transmission from the user who has confirmed the display content of the warning display area R18. When the continue button B20 is selected, the controller 11 executes email transmission. The return button B22 is a button for receiving an instruction to remove the operation screen W30. When input of the selection instruction of the return button B22 is received, the controller 11 ends the display of the operation screen W30 and sets the screen display to only the settings screen W20.

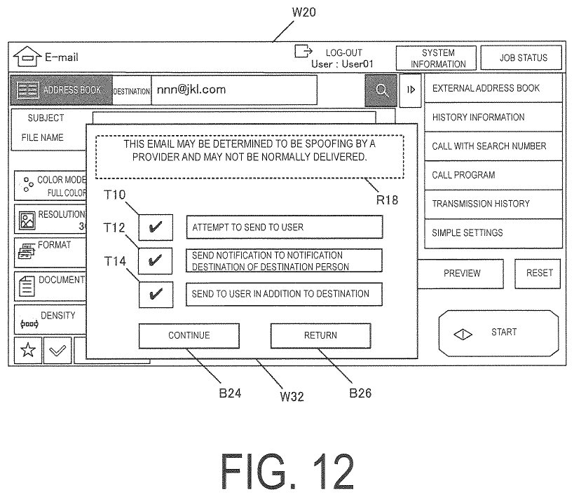

FIG. 12 is a diagram for explaining an example of a display configuration of an operation screen W32 that displays, as an operation option, a handling processing that can be executed as a countermeasure in addition to a warning of the possibility of non-delivery of an email to be transmitted. FIG. 12 illustrates an operation example corresponding to the processing of step S20 (; No) in FIG. 4.

The operation screen W32 includes a check box T10 for attempting to send a notification to the user, a check box T12 for sending a notification to a notification destination of the destination person, a check box T14 for sending to the user in addition to the destination, a continue button B24, and a return button B26.

The check box T10 for attempting to send to the user is a check box for (1) receiving a selection instruction of an operation option related to test-transmission of an email (test email) to a sender who has issued an email transmission instruction. When the check box T10 for attempting to send to the user is checked and the continue button B24 is selected, the controller 11 executes the handling processing illustrated in FIG. 5.

The check box T12 for sending a notification to the notification destination of the destination person is a check box for (2) receiving a selection instruction of an operation option related to the notification to the email recipient. When the check box T12 for sending a notification to the notification destination of the destination person is checked and the continue button B24 is selected, the controller 11 executes the handling processing according to FIG. 6.

The check box T14 for sending to the user in addition to the destination is a check box for (3) receiving a selection instruction of an operation option related to transmitting an email to the sender in addition to the email recipient. When the check box T14 for sending to the user in addition to the destination is checked and the continue button B24 is selected, the controller 11 executes the handling processing according to FIG. 7.

The continue button B24 is a button for receiving an execution instruction for the operation option selected by the user. When the continue button B24 is selected, the controller 11 executes the processing related to the selected operation option. The return button B26 is a button for receiving an instruction to remove the display of the operation screen W32. When input of the selection instruction of the return button B26 is received, the controller 11 ends the display of the operation screen W30 and sets the screen display to only the settings screen W20.

For example, the user can efficiently test whether or not the email to be transmitted will be a non-delivery by checking only the check box T10 for attempting to send to the user and selecting the continue button B24.

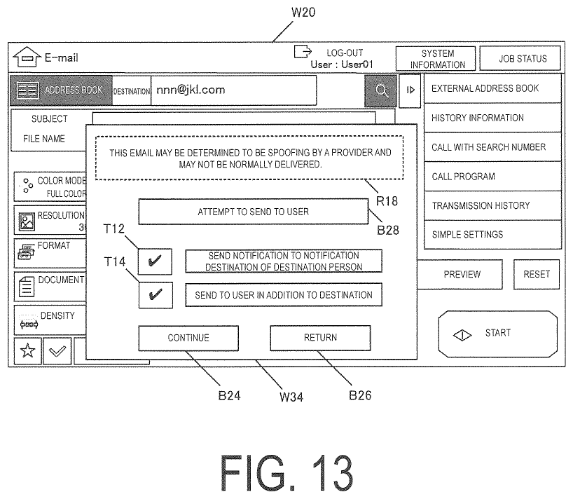

FIG. 13 is a diagram of an operation screen W34 for explaining an example of another display configuration of the operation screen W32 that displays, as an operation option, a handling processing that can be executed as a countermeasure in addition to a warning of the possibility of non-delivery of an email to be transmitted. FIG. 13 illustrates a configuration in which the check box T10 for attempting to send to the user illustrated in FIG. 12 is configured as an execution button for directly executing the test-transmission of the email to the email sender. In FIG. 13, when a button B28 for attempting to send to the user is selected, the controller 11 executes the handling processing illustrated in FIG. 5, and when the continue button B24 is selected with one or both of the check button T12 for sending a notification to the notification destination of the destination person and the check box T14 for sending to the user in addition to the destination being checked, the controller 11 can execute one or both of the processing illustrated in FIG. 6 and FIG. 7. As illustrated in FIG. 13, the screen configuration of the operation screen W34 can be appropriately set and changed according to the priority or the like of the handling processing to be executed by the controller 11. For example, the check button T12 for sending a notification to the notification destination of the destination person may be configured as an execution button, and other operation options (a button B28 for attempting to send to the user, and the check box T14 for sending to the user in addition to the destination) may be configured as check buttons.

Although FIG. 11 to FIG. 13 illustrate examples in which the operation screens W30 to W34 are displayed so as to be superimposed on the settings screen W20, the display of the settings screen W20 may be restricted while the operation screens W30 to W34 are being displayed, and the display of the settings screen W20 may be resumed when the input of the selection instruction of the return button (B22, B26) is received.

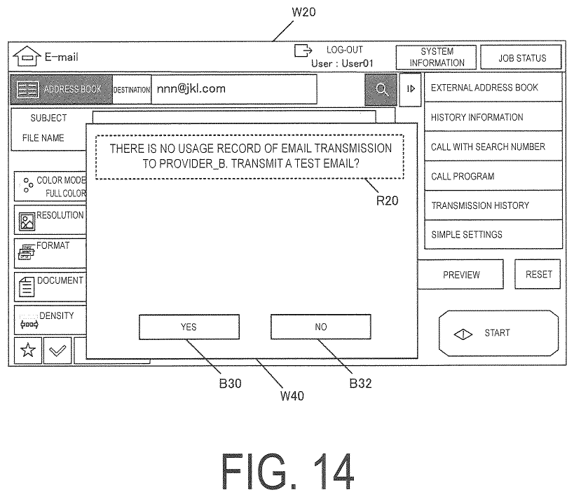

FIG. 14 is a diagram for explaining an example of a display configuration of a test-transmission recommendation message screen W40 for recommending test-transmission of a test email displayed by the controller 11 when it is determined that there is no usage record of email transmission for the provider. FIG. 14 illustrates an operation example corresponding to the processing of step S2216 in FIG. 5.

The test-transmission recommendation message screen W40 includes a test-transmission recommendation message display area R20, a yes button B30, and a no button B32. The test-transmission recommendation message display area R20 is a display area displaying display contents (for example, “There is no usage record of email transmission for the provider_B. Will you transmit a test email?”) recommending a test-transmission of a test message.

The yes button B30 is a button for receiving an input of a test transmission instruction for a test email. When the controller 11 receives an input of a selection instruction of the yes button B30, the controller 11 transmits a test email. The no button B32 is a button for receiving a cancel instruction of a test transmission instruction for a test email. When input of the selection instruction of the no button B32 is received, the controller 11 ends the display of the test-transmission recommendation message screen W40 and sets the screen display to only the settings screen W20.

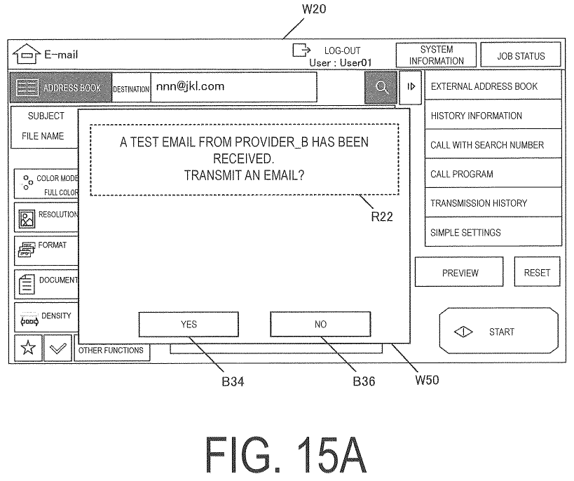

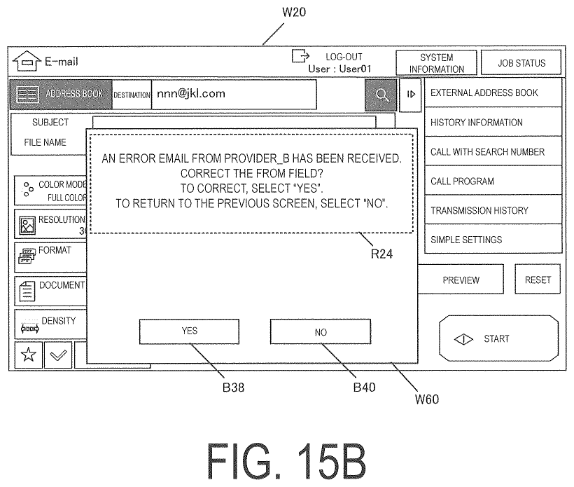

FIG. 15A is a diagram for explaining an example of a display configuration of an arrival confirmation screen W50 displayed by the controller 11 when the arrival of the test email is confirmed. FIG. 15A illustrates an operation example corresponding to the processing of step S2222 in FIG. 5.

The arrival confirmation screen W50 includes a reception confirmation message display area R22, a yes button B34, and a no button B36. The reception confirmation message display area R22 is a display area displaying contents (for example, “A test email has been received from the provider_B. Will you send an email?) querying as to whether or not to transmit an email to the recipient via the target provider upon successful reception of the test-transmitted test message.

The yes button B34 is a button for receiving an input of an email transmission instruction using a target provider. When the controller 11 receives the input of the selection instruction of the yes button B34, the controller 11 transmits an email using the target provider. The no button B36 is a button for receiving a cancel instruction of an email transmission using a target provider. When input of the selection instruction of the no button B36 is received, the controller 11 ends the display of the arrival confirmation screen W50 and sets the screen display to only the settings screen W20.

FIG. 15B is a diagram for explaining an example of a display configuration of an error content display screen W60 displayed by the controller 11 when an error email is received from the transmission destination provider of the test email. FIG. 15B illustrates an operation example corresponding to the processing of step S2224 in FIG. 5.

The error content display screen W60 includes an error content display area R24, a yes button B38, and a no button B40. The error content display area R24 is a display area displaying the content of the error included in the error email received from the target provider and an example of an improvement countermeasure (for example, “An error email has been received from the provider_B. Do you want to correct the From field?”).

The yes button B38 is a button for receiving an input of an instruction to execute the error countermeasure displayed in the error content display area R24. When receiving the input of the selection instruction of the yes button B38, the controller 11 executes the error improvement countermeasure displayed in the error content display area R24. The no button B40 is a button for receiving an instruction to cancel the error improvement countermeasure displayed in the error content display area R24. When receiving the input of the selection instruction of the no button B40, the controller 11 ends the display of the error content display screen W60 and sets the screen display to only the settings screen W20.

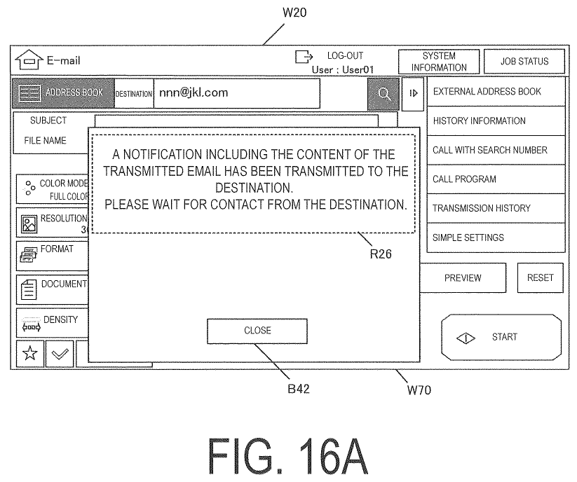

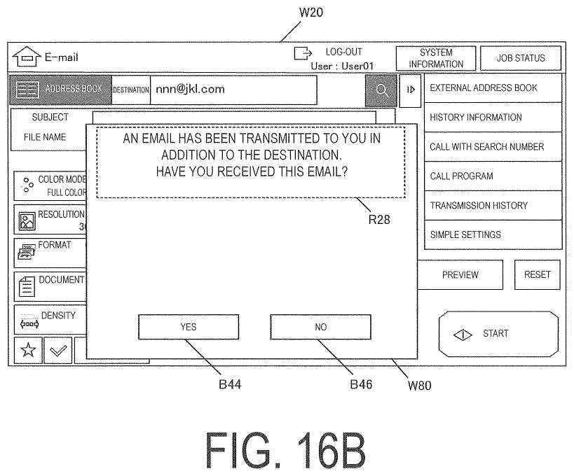

FIG. 16A illustrates an example of a display configuration of a result screen W70 that displays a notification result when notify the email recipient is selected as an operation option. FIG. 16A illustrates an operation example corresponding to the processing of step S2240 in FIG. 6.

The result screen W70 includes a notification result display area R26 and a close button B42. The notification result display area R26 is a display area displaying notification content (for example, “A notification including the contents of the transmitted email has been transmitted to the destination. Please wait for contact from the destination”) indicating that an email has been transmitted to the destination. The close button B42 is a button for receiving an end of display of the result screen W70 from the sender. When a selection instruction of the close button B42 from the user is received, the controller 11 ends the display of the result screen W70 and sets the screen display to only the settings screen W20.

FIG. 16B illustrates an example of a display configuration of a result screen W80 that displays an email transmission result when transmission of an email to a sender in addition to the email recipient is selected as an operation option. FIG. 16B is an operation example corresponding to the processing from step S2250 to step S2252 in FIG. 7.

The result screen W80 includes an email transmission result display area R28, a yes button B44, and a no button B46. The email transmission result display area R28 is a display area displaying content (for example, “An email has been transmitted to you in addition to the destination. Have you received the email?”) indicating that an email has been transmitted and querying as to whether or not the email has been received.

The yes button B44 is a button for receiving a selection by the sender when the transmitted email is received. When the controller 11 receives an input of a selection instruction of the yes button B44 from the user, the controller 11 determines that the reception of the email is successful and ends the processing. The no button B46 is a button for accepting selection by the sender when the email is not received. When the controller 11 receives the input of the selection instruction of the no button B46, the controller 11 determines that the reception of the email has failed, ends the display of the result screen W80, and sets the screen display to only the settings screen W20.

As described above, in the first embodiment, in a case where the email address for logging into the distribution service is different from the email address of the sender of the email, before the email is transmitted, a warning is issued of the possibility of non-delivery of the email and/or handling processing such as (1) test-transmission of an email (test email) to the sender who issued the email transmission instruction, (2) notification to the email recipient, or (3) transmission of the email to the sender in addition to the email recipient is executed. According to the first embodiment, in a case where there is a concern about a possibility of an email being determined as a spoofing email by a provider providing a distribution service in email transmission in which the email address of a user is set in a sender field, it is possible to provide a countermeasure therefor.

### 2. SECOND EMBODIMENT

In the second embodiment, in step S2222 of FIG. 5 of the first embodiment, when an error email is received from a target provider, the error email is analyzed, and when the content of the error is non-delivery of the email, the email transmission mode is switched from the second mode to the first mode.

Since a functional configuration of the communication apparatus 1 and the multifunction peripheral 10 according to the second embodiment can be similar to that in the first embodiment, description thereof will be omitted here.

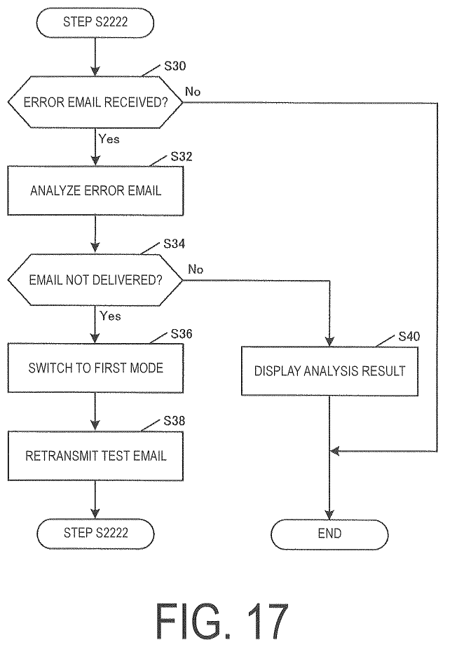

Main processing of the multifunction peripheral 10 according to the second embodiment can be performed in a substantially similar manner to that of the processing according to the first embodiment illustrated in FIG. 4. In the second embodiment, the processing of step S2222 of FIG. 5 will be described with reference to the flowchart illustrated in FIG. 17.

The controller 11 determines whether or not an error email has been received (step S30). In a case where it is determined that an error email has been received, the controller 11 analyzes the content of the error email (step S30; Yes→step S32). On the other hand, in a case where it is determined that an error message has not been received, the controller 11 ends the processing (step S30; No→end).

The controller 11 analyzes the content of the error email and determines whether or not the error is caused by non-delivery of the email (step S34). In a case where it is determined that the content of the error email is caused by the non-delivery of the email, the controller 11 switches the email transmission mode from the second mode to the first mode (step S34; Yes →step S36).

Next, the controller 11 retransmits the test email, and the processing returns to step S2222 in FIG. 5 (step S38→step S2222). In a case where it is determined in step S34 that the content of the error email is not caused by the non-delivery of the email, the controller 11 displays the analyzed error content and ends the processing (step S34; No→step S40→end).

As described above, according to the second embodiment, when an error email is received from a target provider, the error email is analyzed, and when the content of the error email is the non-delivery of the email, the email transmission mode is automatically switched from the second mode to the first mode. Thus, the sender does not need to analyze and understand the content of the error, allowing an effect of reducing the effort needed by the sender to be achieved.

### 3. THIRD EMBODIMENT

The third embodiment is an embodiment, similar to the first and second embodiment, in which the notification of the test result by the transmitted test email is provided.

Since a functional configuration of the communication apparatus 1 and the multifunction peripheral 10 and the processing flow according to the third embodiment can be similar to that in the first or second embodiment, description thereof will be omitted here.

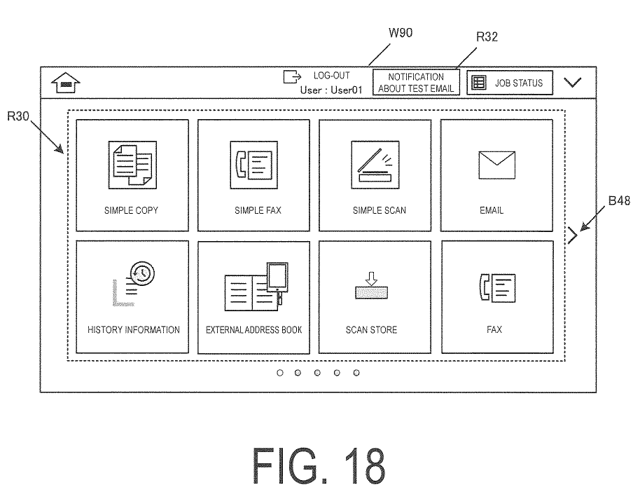

FIG. 18 is a diagram for explaining an example of a display configuration of the home screen W90 including a notification area R32 for providing a notification that the test result by the transmitted test email has reached the multifunction peripheral 10.

The home screen W90 is a basic screen that is displayed on the display 13, for example, at the time of power-on, at the time of standby, at the time of recovery from sleep mode, and the like, and receives an operation input by the user. The home screen W90 includes a job function display area R30, a job function display area switching button B48, and the notification area R32.

The job function display area R30 is an area for collectively displaying job function selection buttons for receiving selection of a job function and display instruction input of the setting history screen. The job function selection button is a selection button having a screen configuration in which each job function, each piece of information, and the like is illustrated by a graphic, a character, a number, a symbol, or the like.

The job function display area R30 illustrated in FIG. 18 is an example display area configured to include job function selection buttons for receiving job function selection of a simple copy button, a simple fax button, a simple scan button, an email button, a history information button, an external address book button, a scan save button, and a fax button as selection buttons and input of a settings history screen display instruction.

The job function display area switching button B48 receives an instruction input by the user when switching the display content of the job function display area R30. When an input instruction of the job function display area switching button B48 by the user is received, the controller 11 can switch the display content of the job function display area R30 by switching the displayed job function selection button.

The notification area R32 is a display area for displaying contents notifying the sender of the reception of the transmitted test email or the reception of the error email. The user can easily recognize the success or failure of the test by the test email by checking the notification content displayed in the notification area R32.

As described above, according to the third embodiment, by providing the notification area R32 for providing a notification of the success or failure of the test by the test email on a basic screen such as the home screen W90, the sender can recognize the success or failure of the test even when, for example, it takes time to distribute the email and the sender moves away from the settings screen W20 (screen transition). Note that it is also possible to perform display control such that the notification area R32 is displayed when the sender of the email is a login user and is not displayed when a login user different from the sender is operating the multifunction peripheral 10.

### 4. MODIFIED EXAMPLE

The disclosure is not limited to the embodiments described above and can be changed in various manners. In other words, embodiments obtained by combining technical mechanisms appropriately changed without departing from the gist of the disclosure are also included in the technical scope of the disclosure.

Although some parts of the above-described embodiments are described separately for convenience of explanation, it is a matter of course that combinations can be executed within a technically allowable range.

The programs running on each device in the embodiments are programs for controlling a CPU or the like (programs for causing a computer to function) to implement the aforementioned functions in the embodiments. The information handled by these devices is temporarily accumulated in a transitory storage device (for example, a RAM) at the time of processing, is then stored in a storage device such as various read only memories (ROMs) or HDDs, and is read, corrected, and written by the CPU as needed.

The recording medium storing the programs may be any of a semiconductor medium (for example, a ROM, a nonvolatile memory card, or the like), an optical recording medium or a magneto-optical recording medium (for example, a digital versatile disc (DVD), a magneto optical disc (MO), a mini disc (MD), a compact disc (CD), a Blu-ray (trade name) disc (BD) or the like), a magnetic recording medium (for example, a magnetic tape, a flexible disk, or the like), and the like. Not only the aforementioned functions of the embodiments are implemented by executing the loaded programs, but also the functions of the disclosure may be implemented by performing processing in cooperation with an operating system, another application program, or the like based on commands of the programs.

In a case where the programs are distributed to the market, the programs can be stored and distributed in a portable recording medium, or can be transferred to a server computer connected via a network such as the Internet. In this case, it is a matter of course that the storage device of the server computer is also included in the disclosure.

### REFERENCE SIGNS LIST

1 Communication apparatus
10 Multifunction peripheral
11 Controller
13 Display
15 Operation inputter
17 Communicator
19 Storage
191 Control program
192 Display processing program
193 Email program
194 Mode setting program
195 Handling processing program
196 Authentication program
197 Provider login information storage area
198 User information storage area
21 Image processor
23 Image inputter

1. A communication apparatus comprising:
a display that displays an operation screen for transmitting an email using a distribution service; and
one or more controllers that control transmission of an email on a basis of an input content input via the operation screen, wherein
in a case where an email address for logging into the distribution service and an email address of a sender of the email are different, before the email is transmitted, the one or more controllers display on the operation screen one or both of a warning of a possibility of non-delivery of the email and an operation option for checking arrival of the email.

2. The communication apparatus according to claim 1, wherein
the one or more controllers execute handling processing on a basis of the operation option selected by a user.

3. The communication apparatus according to claim 2, wherein
the handling processing includes test-transmission of the email to the sender, transmission of an email to the sender in addition to a recipient of the email, or notification to the recipient.

4. The communication apparatus according to claim 3, wherein
the one or more controllers check a transmission history of the email by the sender and performs a test-transmission to the sender in a case where the email has not been transmitted via the distribution service within a predetermined time period.

5. The communication apparatus according to claim 1, further comprising
an authenticator that authenticates a user to log into the communication apparatus, wherein the email address of the sender is an email address of an authenticated user authenticated by the authenticator.

6. A communication apparatus comprising:
one or more controllers that control transmission of an email in either a first mode or a second mode selected by a user when transmitting the email, the first mode being a mode in which an email is transmitted with an email address for logging into a distribution service being a display address and the second mode being a mode in which an email is transmitted with an email address of a sender input in an operation screen being a display address; and
a transmitter that transmits the email on a basis of control by the one or more controllers, wherein
in a case where the second mode has been selected by the user, the one or more controllers,
in a case where an email address for logging into the distribution service and an email address of a sender of the email are different, before the email is transmitted, displays on the operation screen one or both of a warning of a possibility of non-delivery of the email and an operation option for checking arrival of the email.

7. An email transmission control method comprising:
displaying an operation screen for transmitting an email using a distribution service; and
controlling transmission of an email on a basis of an input content input via the operation screen; and
in a case where an email address for logging into the distribution service and an email address of a sender of the email are different, before the email is transmitted, displaying on the operation screen one or both of a warning of a possibility of non-delivery of the email and an operation option for checking arrival of the email.
